(19) United States
(12) Patent Application Publication
(10) Pub. No.: US 2020/0227764 A1
(43) Pub. Date: Jul. 16, 2020

(54) Combined Hydrogen and Electrical Power Generation System and Method

(71) Applicant: W. Grover Coors, Golden, CO (US)

(72) Inventor: W. Grover Coors, Golden, CO (US)

(21) Appl. No.: 16/547,168

(22) Filed: Aug. 21, 2019

Related U.S. Application Data
(60) Provisional application No. 62/791,983, filed on Jan. 14, 2019.

(51) Int. Cl. H01M 8/0656; H01M 8/0612; H01M 8/18; H01M 4/86

(52) U.S. Cl. CPC H01M 8/0656; H01M 8/0612; H01M 2250/10; H01M 4/8621; H01M 8/184

(57) ABSTRACT

A combined hydrogen and electrical power generation system includes a solid oxide fuel cell (SOFC) having a cathode and an anode and a protonic ceramic hydrogen separation membrane (PSM) having a cathode and an anode. The SOFC and the PSM are connected in electrical series having a common current.

### BACKGROUND

Hydrogen is most commonly produced on a large industrial scale by steam methane reforming (SMR) followed by partial swing adsorption (PSA), or alternatively by electrolysis of water. Hydrogen produced by these processes can be used in fuel cells for generating electric power, compressed and stored for later use on-site or for delivery to some other site. The hydrogen may also be used as a reagent in chemical processes, or even run in clean-burning internal combustion engines.

Current SMR/PSA hydrogen production processes requires both an adequate supply of natural gas and an adequate supply of electricity to power the SMR and PSA reactors. Furthermore, water electrolysis is electricity intensive and requires adequate source of water. These processes typically require long distance piping or hauling of natural gas and/or water to hydrogen production plants located within proximity of an external utility grid for powering process and plant equipment, etc.

It would be most beneficial if a system/process were developed which would allow for distributed production of hydrogen without the need to power process equipment with electricity derived from an external utility grid. Such a process would allow for the generation and use of hydrogen in remote locations where access to an external electricity source is not available. Such a system/process would have enormous utility and the benefits thereof are self-explanatory.

### BRIEF SUMMARY OF INVENTION

The present invention solves these and other problems in the art by provisions of a combined hydrogen and electrical power generation (CH₂P) system and method. The systems and processes of the present invention require no connection to an external utility grid for powering process equipment for generation of hydrogen. Accordingly, the processes and systems of the present invention, can be employed in remote locations where a fuel source is present but there is no external access to electricity. Contemplated locations and applications for the present CH₂P system and method include, for example, in the field next to a fossil fuel well head or renewable hydrocarbon source or in any other location having a sufficient supply of a hydrocarbon fuel (e.g. on a ship, on a train, etc.).

In a first embodiment, the present invention provides a CH₂P generation system comprising: a solid oxide fuel cell (SOFC) having a cathode and an anode; and a protonic ceramic hydrogen separation membrane (PSM) having a cathode and an anode. The SOFC and the PSM are connected in electrical series having a common current. The convention used, herein, is that the cathode is the electrode where electrons are consumed, and the anode is the electrode where electrons are given up.

In a second embodiment, the present invention provides a CH₂P generation system comprising:

a solid oxide fuel cell (SOFC) having a cathode and an anode;
a protonic ceramic hydrogen separation membrane (PSM) having a cathode and an anode; and
an oxygen supply, a fuel gas channel, and a product hydrogen channel;
wherein:
   the SOFC and the PSM are connected in electrical series having a common current,
   the cathode of the SOFC is in electrical connection with the anode of the PSM, and the cathode of the PSM is in electrical connection with the anode of the SOFC,
   the oxygen supply, the fuel gas channel, and a product hydrogen channel are each adapted for continuous or semi-continuous flow,
   the oxygen supply comprising ambient air, compressed air, or compressed oxygen which is in fluid communication with the cathode of the SOFC,
   the hydrogen channel comprising H₂ which is in fluid communication with the cathode of the PSM,
   the fuel gas channel is a common channel disposed between and in fluid communication with both the anode of the SOFC and the anode of the PSM,
   the fuel gas channel has: an inlet and an outlet; a gas content at the inlet containing a mixture of gases including H₂O, CO, CO₂, H₂, and low molecular weight hydrocarbons; and a gas content at the outlet containing the same gases but less than 10 mol % H₂,
   between the inlet and the outlet, the fuel gas channel is closed to the introduction or removal of gas species other than introduction of oxygen as oxygen ions at the SOFC anode and removal of hydrogen as hydrogen ions (protons) at the PSM anode, and
   the system requires no connection to an external power source for providing power to the system.

In a third embodiment, the present invention provides a CH₂P generation method comprising the steps of:

(i) providing a CH₂P generation system comprising: a solid oxide fuel cell (SOFC) having a cathode and an anode; a protonic ceramic hydrogen separation membrane (PSM) having a cathode and an anode; wherein the SOFC and the PSM are connected in electrical series having a common current, and wherein the cathode of the SOFC is in electrical connection with the anode of the PSM, and the cathode of the PSM is in electrical connection with the anode of the SOFC,
(ii) contacting the cathode of the SOFC with an oxygen supply,
(iii) contacting both the anode of the SOFC and the anode of the PSM with a fuel gas,
(iv) receiving hydrogen from the cathode of the PSM, and
(v) allowing a current to flow from the cathode of the SOFC to the anode of the PSM, across an electrolyte disposed between the anode of the PSM and the cathode of the PSM, from the cathode of the PSM to the anode of the SOFC, across an electrolyte disposed between the anode of the SOFC and back to the cathode of the SOFC.

### DRAWINGS

FIG. 1 shows an embodiment of the arrangement of the CH₂P system.

FIG. 2A shows an embodiment of the arrangement of the CH₂P system.

FIG. 2B shows an embodiment of the arrangement of the CH₂P system.

FIG. 2C shows an embodiment of the arrangement of the CH₂P system.

FIG. 3 shows an equivalent CH₂P circuit with a variable series load resistance.

FIG. 4 shows an embodiment of the arrangement of the CH2P system in cross-section.

FIG. 5A shows mole fractions of H₂, H₂O, CO and CO₂ at equilibrium at 1000K vs. O₂/CH₄ in a SOFC.

FIG. 5B shows E_{sofc} (left axis) and pH₂/pH₂O (right axis) in a SOFC.

FIG. 6 shows a plot of the cell current and load voltage as a function of load resistance.

### DETAILED DESCRIPTION

The present invention provides inter alia combined hydrogen and power generation, CH₂P, systems and methods which allow for convenient and cost-effective ways to produce hydrogen independently of the utility grid. The CH₂P concept involves partial oxidation of hydrocarbon feedstocks using a solid oxide fuel cell to generate a hydrogen-rich gas mixture. Pure hydrogen is extracted from the resulting mixture and compressed using a protonic ceramic separation membrane, PSM. The power required to operate the PSM and additional compression downstream is provided by the SOFC. High purity hydrogen is thus produced that is suitable for use directly in PEM fuel cells without additional processing, and can then be transferred to external storage tanks for future (or concurrent) use. The stand-alone systems and methods offer clean, quiet and efficient hydrogen production for fuel cell power generation from a wide variety of fossil-based and renewable hydrocarbon feed-stocks.

CH₂P is a method for producing pure hydrogen in a device that does not require any external power source. Furthermore, the system is scalable from grams of hydrogen per hour to tons per day, and is, thus, suited for distributed hydrogen production. In the system, a solid oxide fuel cell, SOFC, is used to partially oxidize a gasified hydrocarbon feedstock. The resulting hydrogen-rich fuel mixture flows through an integrated protonic ceramic separation membrane, PSM, operating at about the same temperature, where the hydrogen is galvanically separated and compressed. Further compression to higher hydrogen pressure, if required, may also be carried out using electric power from the SOFC. Some electrical power from the SOFC may also be available for operating control systems and auxiliary loads. The proportion of the power available to produce hydrogen depends on the particular operating scenario and the demand for electricity versus hydrogen. The hydrogen thus produced may be used on-site in fuel cells for generating electric power, compressed and stored for later use on-site or for delivery to some other site. The hydrogen may also be used as a reagent in chemical processes, or even run in a clean-burning internal combustion engine. A salient feature of CH₂P is that a self-contained, integrated system, independent of any external electrical power source, is capable of producing pressurized hydrogen and preferably some electric power over a wide operating range and at high net energy conversion efficiency. The energy required for fuel processing and compression is obtained by consuming some portion of the fuel in a SOFC, which makes the system portable and independent of any fixed infrastructure. Similar to portable diesel generators, a principle difference is that a portable diesel generator produces only electric power, whereas a CH₂P system produces hydrogen on-site, and preferably some auxiliary electric power. This enables deployment of hydrogen fuel cells in a wide range of mobile applications from trucks to trains to ships, which currently rely on fixed-based hydrogen ‘filling-stations’.

The CH₂P systems and methods of the present invention offer an elegant and novel pathway for transitioning from power provided by internal combustion engines to hydrogen power. The present invention demonstrates that with electrical and thermal integration between SOFC and PSM cells, hydrocarbon feedstocks may be converted to hydrogen. In preferable embodiments, this is done with a net gain in available work when the resulting hydrogen is consumed in fuel cells, extending the range and endurance of mobile power systems over conventional liquid fuels when combusted in heat engines. Furthermore, the CH₂P systems and methods of the present invention are fuel agnostic, obviating the need for specialized fuels for engines, for example gasoline, diesel and jet fuel. Instead, hydrogen may be generated from a wide range of hydrocarbon feedstocks. Solid fuels from fossil-based and plant-based sources are readily available. Biomass also provides an opportunity to increase the use of carbon-neutral fuels while reducing dependence on imported petroleum. With the CH₂P systems and methods of the present invention, hydrogen may be produced remotely at almost any scale from a few grams to tons of feedstock without the need for access to crude oil, utility/power grid, or natural gas pipelines.

### Combined Hydrogen to Power (CH₂P) System and Methods:

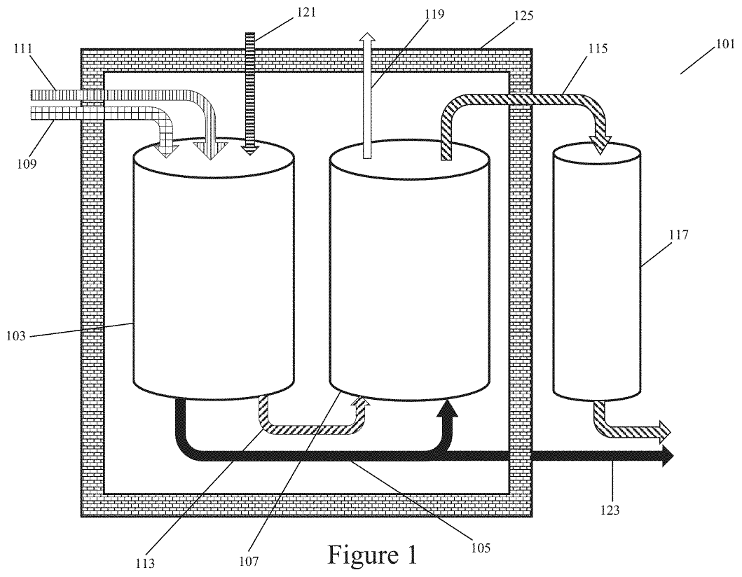

As shown in FIG. 1, a CH₂P system 101 according to one embodiment of the present invention has two main components: a solid oxide fuel cell (SOFC) 103 connected in electrical series 105 with a protonic ceramic separation membrane (PSM) 107. Gasified hydrocarbon feedstock 109 is fed to the SOFC 103, optionally along with steam or water vapor or a separate steam or water vapor feed stream 111 and also optionally with oxygen or a separate oxygen supply line 121, which generates electrical power by partial oxidation of the feedstock to produce a hydrogen-rich gas mixture (e.g. mixed reformate gas stream 113). The SOFC 103 is positioned upstream of the PSM 107, which subsequently extracts hydrogen from a mixed gas steam (preferably the mixed reformate gas stream 113 exiting the SOFC 103) and electrochemically compresses it for delivery downstream, for example via product hydrogen line 115 to an optional hydrogen storage vessel 117. The hydrogen produced in this manner is purified because largely only hydrogen ions pass through the dense ceramic membrane of the PSM 107. Other gas species (for example CO₂) are excluded and pass out of the system 101 as exhaust, for example via exhaust line 119.

Separation and compression in the PSM 107 are carried out galvanically to some pressure which is limited by the mechanical strength of the various components. Electrochemical separation and compression require electrical power. This power can be provided by electricity 105 provided by the SOFC 103 by consuming some portion of the hydrocarbon fuel gas supply 109 and as described later most preferably by consuming some portion of a common reformate hydrocarbon fuel gas supply that is also in contact with the PSM 107. The electrical power required to operate the PSM 107 and other internal loads required for self-sustaining operation of the CH₂P systems 101 and methods (and preferably external loads) are preferably entirely provided 105 by the SOFC 103. For example, other internal loads required for self-sustaining operation of the CH₂P systems 101 and methods include internal heaters for the SOFC 103 and/or PSM 107, preheaters for preheating steam and/or a hydrocarbon fuel source 109 to be used in the system 101. Although not required, it is preferred that operation of the SOFC 103 in the CH₂P systems 101 and methods of the present invention provides additional/supplemental electrical power 123 that can also be used to power external loads which are not required for self-sustaining operation of the CH₂P systems 101 and methods. Examples of these external loads include, for example, a gas compressor for further compression hydrogen produced by the system beyond that which is provided by the PSM, a battery bank, a process control system, facility or plant loads, and an external power/utility grid (e.g. put back on the grid). These external or internal loads can be disposed anywhere in series in the circuit and are preferably located between the cathode of the SOFC 103 and the anode of the PSM 107 or between the anode of the SOFC 103 and the cathode of the PSM 107.

Using the presently described CH₂P systems 101 and methods, high purity hydrogen can be produced that is suitable for use on-site directly in PEM fuel cells without additional processing or transferred to external high-pressure storage tanks 117 for future use on-site or transported. The stand-alone CH₂P systems 101 and methods of the present invention offer clean, quiet and efficient hydrogen production for fuel cell power generation or reactant use from a wide variety of fossil-based and renewable feedstocks without the need for connecting to an external source of electric power. Accordingly, the systems and methods require and/or have no connection to an external power source, utility/electric/power grid for providing power to the system 101 and/or methods.

Both the PSM 107 and SOFC 103 operate at high temperature—typically between 600° C. and 1000° C., and more preferably between 700° C. and 800° C. Accordingly, it is advantageous to have the integrated fuel cell and separation membrane operate at about this same temperature. By integrating the SOFC 103 and PSM 107 into the same insulated CH₂P system 101, energy requirements for the system 101 may be met at high efficiency with the least amount of heat rejection to the surroundings. Preferably, and as shown in FIG. 1, the SOFC 103 and PSM 107 are integrated into an insulated and/or adiabatic enclosure 125 while the external H₂ storage tank 117 is at ambient temperature to minimize heat transfer to the ambient environment. In additional preferred embodiments, supply lines to the CH₂P system are in heat exchange with product and exhaust lines exiting the system 101.

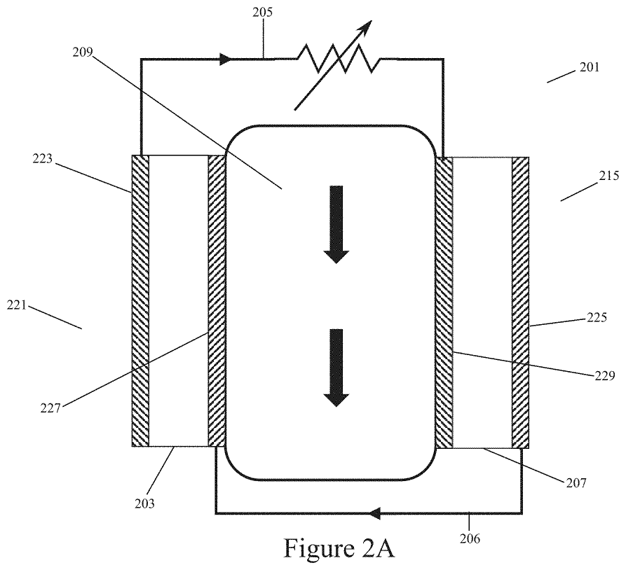

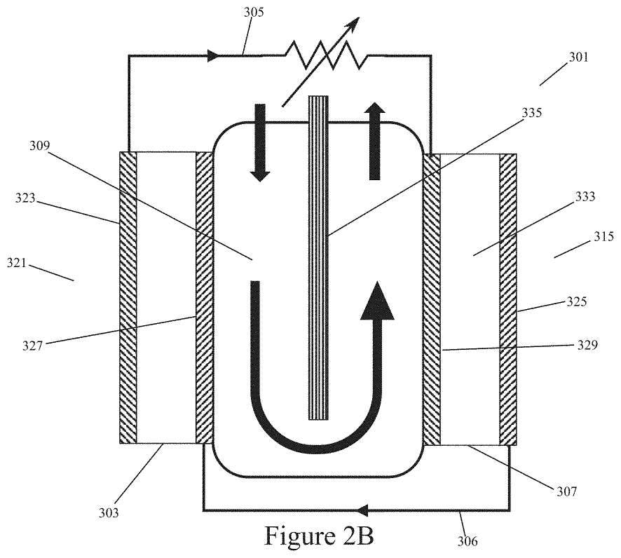

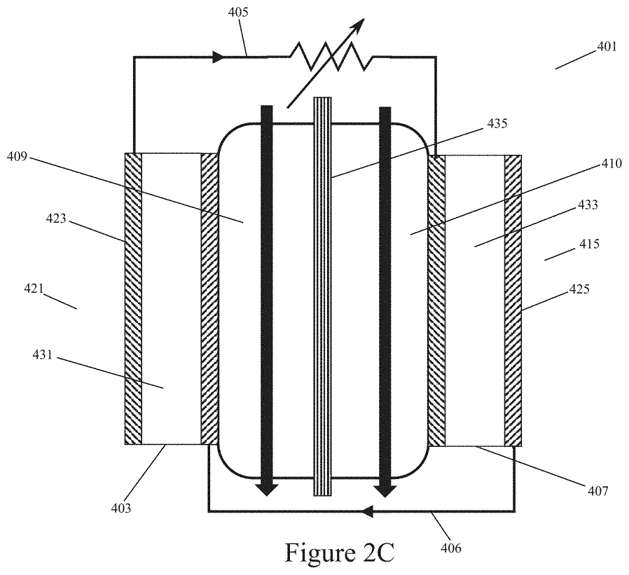

FIG. 2A shows a preferred embodiment of the arrangement of the CH₂P system 201 including the SOFC 203 (left), PSM 207 (right) and electrical interconnects 205, 206 with respect to three gas channels or reservoirs (oxygen supply 221, a common hydrocarbon reformate channel 209, and a product hydrogen channel 215). 1) The SOFC 203 cathode 223 (left) is supplied with (e.g. is in fluid communication with) oxygen or air preferably at ambient or compressed pressures 221. It is noted herein, unless otherwise described, that the oxygen supply 221 of this embodiment and of others can mean that the cathode of the SOFC 203 is simply in fluid communication with ambient air or the environment. In other embodiment, oxygen supply 221 may be a separate channel plumbed with oxygen or enclosed reservoir containing oxygen. 2) the PSM 207 cathode 225 (right) is attached to (e.g. in fluid communication with) a flow channel or reservoir for purified hydrogen 215, and 3) the central reservoir (common flow/fuel gas channel) 209 is disposed between and in fluid communication with the anodes 227, 229 of both of the SOFC 203 and PSM 207 and contains some mixture of low molecular weight hydrocarbon gasses plus H₂O, CO, CO₂ and H₂. Each gas channel/reservoir 209, 215, 221 is independently adapted for continuous flow, semi-continuous flow, or batch conditions. The SOFC 203 and the PSM 207 are connected in electrical series having a common current wherein the cathode 223 of the SOFC 203 is in electrical connection 205 with the anode 229 of the PSM 207, and the cathode 225 of the PSM 207 is in electrical connection 206 with the anode 227 of the SOFC 203.

FIG. 2B shows another preferred embodiment of the arrangement of the CH₂P system 301 including the SOFC 303 (left), PSM 307 (right) and electrical interconnects 305, 306 with respect to three gas channels or reservoirs (oxygen supply 321, a common hydrocarbon reformate fuel gas channel 309, and a product hydrogen channel 315). 1) The SOFC cathode 323 (left) is supplied with oxygen or air 321. 2) the PSM cathode 325 (right) is attached to a flow channel 325 or reservoir for pure hydrogen, and 3) the central reservoir or common flow channel 309 contains some mixture of low molecular weight hydrocarbon gasses, plus H₂O, CO, CO₂ and H₂. Disposed within the common hydrocarbon reformate gas channel 309 is an intermediate wall 335 to direct flow of reformate gas. In this embodiment, the reformate gas is directed toward and first flows along the anode 327 of the SOFC 303 where hydrogen concentration increases. The reformate gas then is allowed to cross over to and flow along the anode 329 of the PSM 307, where hydrogen concentration decreases as it is withdrawn from the system 301 across the electrolyte matrix 333 of the PSM 307.

FIG. 2C shows another embodiment of the arrangement of the CH₂P system 401 including the SOFC 403 (left), PSM 407 (right) and electrical interconnects 405, 406 with respect to four gas channels or reservoirs (oxygen supply 421, two separate hydrocarbon reformate channels 409, 410, and a product hydrogen channel 415). 1) The SOFC cathode 423 (left) is supplied with oxygen or air 421. 2) the PSM cathode 425 (right) is attached to a flow channel 415 or reservoir for pure hydrogen, and 3) the central reservoir or common flow channels 409, 410 contains some mixture of low molecular weight hydrocarbon gasses, plus H₂O, CO, CO₂ and H₂. In this embodiment there are two separate reformate gas channels 409, 410 that are independent of each other. However, since the SOFC 403 and PSM 407 are connected 405, 406 in electrical series with a common current, the Oxygen flux across the matrix 431 of the SOFC 403 is balanced by hydrogen flux across the matrix 433 the PSM 403. As explained below, under preferred operating conditions the reformate gas exiting the SOFC 403 via channel 409 will have an elevated hydrogen concentration and residual useful hydrocarbon fuel for consumption. Accordingly, this stream can be used in other processes (e.g. such as combustion), it can be piped into PSM 407 fuel channel 410, and/or it can be used in a separate PSM reactors external to the CH₂P system 401 to produce hydrogen.

In the embodiments shown in FIGS. 2A and 2B, the hydrocarbon reformate fuel gas channel is a common channel 209, 309 disposed between and in contact/fluid communication with the anodes 227, 327, 229, 329 of both of the SOFCs 203, 303 and the PSMs 207, 307. In these embodiments the common fuel gas channel 209, 309 preferably has an inlet and an outlet, wherein between the inlet and the outlet the fuel gas channel 209, 309 is closed to the introduction or removal of gas species other than introduction of oxygen at the SOFC 203, 303 anode 227, 327 and removal of hydrogen at the PSM 207, 307 anode 229, 329. As fuel gas flows along the surface of the anode 227, 327 of the SOFC 203, 303 hydrogen concentration increases whereas as fuel gas flows along the surface of the PSM 207, 307 anode 229, 329 hydrogen concentration decreases. In preferred embodiments, the concentration of hydrogen in gas at the outlet of the common fuel gas channel 209, 309 is less than 20 mol %, more preferably less than 10 mol %, and most preferably less than 5 mol %, for example 2 mol %, 1 mol % or no detectable hydrogen (via H¹ NMR or gas chromatography analysis).

The present application likewise provides a method to produce electrical power and hydrogen. The method includes the steps of: (i) providing any of the CH₂P systems described herein; (ii) contacting the cathode of the SOFC with an oxygen supply (preferably comprising ambient air, compressed air, or compressed oxygen); (iii) contacting both the anode of the SOFC and the anode of the PSM with a fuel gas (preferably a fuel gas that is disposed in a common channel between and in fluid communication with the anodes of both the SOFC and the PSM); (iv) receiving or collecting hydrogen from the cathode of the PSM; and (v) allowing a current to flow from the cathode of the SOFC to the anode of the PSM, across an electrolyte disposed between the anode of the PSM and the cathode of the PSM, from the cathode of the PSM to the anode of the SOFC, across an electrolyte disposed between the anode of the SOFC and back to the cathode of the SOFC. The method optionally further comprises the step of allowing the current to flow through an additional internal or external load. No connection to an external power source is required for powering the method.

### Definitions

As used in the specification and claims of this application, the following definitions, should be applied.

“a”, “an”, and “the” as an antecedent refer to either the singular or plural. For example, “an ester compound” refers to either a single species of compound or a mixture of such species unless the context indicates otherwise.

“cathode” refers throughout to the electrode where electrons are consumed, and “anode” refers throughout to the electrode where electrons are generated, by heterogeneous electrochemical reactions at the interface between the gas and solid phase.

Reference throughout the specification to “one embodiment,” “another embodiment,” “an embodiment,” “some embodiments,” and so forth, means that a particular element (e.g., feature, structure, property, and/or characteristic) described in connection with the embodiment is included in at least one embodiment described herein, and may or may not be present in other embodiments. In addition, it is to be understood that the described element(s) may be combined in any suitable manner in the various embodiments and such combinations are within the scope of the present invention.

### CH₂P Operation:

Without being bound by particular mechanisms of operation, the following discussion is provided with respect to preferred embodiments of the present invention and in particular with respect to the current understanding of operation of these embodiments. In these preferred embodiments, the commercial viability of CH₂P depends on generating an amount of hydrogen that can do at least as much useful work when consumed in a fuel cell as the original fuel might have done if simply burned in a heat engine. Commercial viability is believed to be possible because fuel cells are inherently more efficient than heat engines by virtue of not being subject to the limitation of the Carnot Cycle. Hydrocarbons may be combusted in a heat engine to produce carbon dioxide and water to generate power. On the other hand, converting a hydrocarbon into H₂ first takes energy, but when the hydrogen thus produced is consumed in a PEM fuel cell, more net power may be generated as a consequence of the higher energy conversion efficiency. This comparison is also enhanced by the fact that for many applications, hydrogen has more ‘value’ as a fuel because it is cleaner-burning with far less noise than a conventional heat engine.

A CH₂P system contains two principle components: a solid oxide fuel cell, SOFC, coupled to a protonic ceramic separation membrane, PSM. Gasified hydrocarbon feedstock is fed to the SOFC, which generates electric power by partial oxidation to produce a hydrogen-rich gas mixture. The PSM subsequently extracts hydrogen from the mixed gas steam and electrochemically compresses it for delivery to an external storage tank. Separation and compression in the PSM are carried out galvanically, which requires electrical power. This power is provided by the SOFC, consuming some portion of the fuel enthalpy.

The PSM operates at high temperature—typically between 700° C. and 800° C. It is advantageous to have the SOFC and PSM operate at about this same temperature. Solid oxide fuel cells are ideal for this application. By integrating the SOFC and PSM into the same unit, the energy requirements may be met at the highest possible efficiency with the least amount of heat rejected to the surroundings. The CH₂P system is shown schematically in FIG. 1. In this embodiment, the SOFC and PSM are integrated into an insulated (e.g. isothermal/adiabatic) enclosure. The external H₂ storage tank is at ambient temperature.

The hydrogen separation element in a CH₂P system is a protonic ceramic separation membrane, PSM, which is an electrochemical device with a thin membrane of ceramic proton conductor sandwiched between two electrodes. In the common fuel channel, the gaseous fuel and steam enter at one end and the exhaust exits at the other. Both the SOFC anode and the PSM cathode are adjacent to this channel. Hydrogen removal from the fuel channel at this electrode shifts the reaction equilibrium to consume H₂O and CO to generate CO₂ and more H₂. Hydrogen is driven across the membrane as a current of hydrogen ions by an applied voltage. Pure hydrogen is produced because hydrogen diffuses through the electrolyte membrane as ions. Electrochemical hydrogen compression (EHC) can be carried out by applying an over-voltage sufficient to drive hydrogen against its pressure gradient. The PSM compresses hydrogen on the downstream side to greater than ambient atmospheric pressure, typically up to about 5 bars. Higher pressure is possible, but compressing hydrogen at high temperature is energy-intensive and generally not cost-effective.

Energy is dissipated in the membrane reactor as heat. Isothermal electrochemical hydrogen compression requires energy and generates heat. The current of hydrogen ions passing through the membrane also generates I²R joule heat. The combination of joule heat and compression heat balance with the heat required for endothermic reforming reactions and heating of reactants. Any additional heat is rejected from the system by convection. In preferred embodiments of the CH₂P systems and methods, the power to operate the PSM comes exclusively from the SOFC, as there is no requirement that the CH₂P system be powered via another power source. The SOFC and PSM preferably operate isothermally, so thermal management becomes an important design objective so as to preferably avoid localized heating. Operation is preferably carried out such that heat generated and heat consumed, or rejected, exactly balance. The hydrogen flux through the membrane is proportional to the current density. Just as with SOFC cells, PSM cells may be arranged in series and parallel. System size and capital cost scale with membrane area, so it is beneficial and preferable to operate at the highest feasible current density.

### Thermochemistry:

Without being bound by particular mechanisms of operation, the following discussion is provided with respect to preferred embodiments of the present invention and in particular with respect to the current understanding of operation of these embodiments. According to the present embodiment, the hydrocarbon feedstock may be almost any hydrocarbon containing C—H bonds. The underlying operating principle involves generating H₂ by breaking these C—H bonds and replacing them with C—O bonds, while preferably excluding formation of O—H bonds. In principle, any hydrocarbon molecule can be gasified, including coal, crop residue and municipal solid waste, etc. The only requirement is that it is compatible with the fuel-side electrode of a SOFC (e.g. preferably present in a gasified form). In this sense, CH₂P is preferably independent of fuel selection, accepting a wide range of fossil-based and non-fossil-based hydrocarbons.

Complete combustion of a hydrocarbon molecule containing n carbon, m hydrogen, and p oxygen atoms follows the generalized reaction,

$${C}_{n} {H}_{m} {O}_{p} + ( n + \frac{m}{4} - \frac{p}{2} ) {O}_{2} \to {nCO}_{2} + ( \frac{m}{2} ) {H}_{2} O , Δ {H}_{c}^{°} [ \frac{kJ}{mol} ] \qquad ( 1 )$$

Standard combustion enthalpies, ΔH_{C}°, are available from thermochemical tables. With preferred and complete (stoichiometric) combustion, carbon dioxide and water are the exhaust products. The intent of the stand-alone SOFC is to maximize the useful work that can be extracted by burning fuel. Solid oxide fuel cells have demonstrated impressive efficiencies in combined heat and power systems (CHP), where the system typically generates about ⅓ electric power with the balance given off as heat. This is attractive in scenarios were the heat can be used directly, such as in homes where it can provide hot water and space heat. For many stand-alone applications, however, this heat is not useable and must be released to the atmosphere, making SOFCs only marginally more efficient than conventional heat engines for producing electric power in the final analysis. The reason for this is that the maximum output power is achieved when about half the fuel is consumed. Beyond this point, the cell power drops as the voltage drops at higher and higher fuel utilization. It is thus necessary to slip un-combusted fuel with the exhaust and recycle it or burn it downstream to make heat. An attractive feature of the CH₂P systems and methods of the present invention, is that the residual hydrogen in the SOFC exhaust is extracted by the PSM with the generation of much less waste heat. In a preferably designed system, the SOFC may be operated in the region of maximum efficiency-around 65%.

In the case of CH₂P, it is preferable to only partially oxidize the hydrocarbon so that carbon dioxide and hydrogen are the primary reaction products, while generating as little water vapor as possible. Taking methane as a representative fuel, the net reaction is,

CH₄+O₂+xH₂O=CO₂+2H₂+xH₂O (2)

The sources of oxygen include molecular oxygen and/or water vapor. With partial oxidation, the preferable goal is to generate the maximum amount of hydrogen-two moles of hydrogen generated per mole of methane, in this case. Extra steam is preferably blended with the fuel to prevent coking by pyrolysis. In this embodiment, the ratio of steam to carbon, S/C, is an important operating parameter. CO₂ and H₂ are preferably the only reaction products. Water generated by partial oxidation is subsequently converted into CO₂ and H₂. In the case of methane, the same amount of water exits the fuel channel as entered. For longer chain hydrocarbons, however, some steam is consumed. Some heat energy is required to melt, heat, and vaporize the feedstock. Heat is also required to make steam. Finally, heat is required by the endothermic reforming reaction whether originating from the fuel cell anode or from injected steam upstream, etc. In principle, partial oxidation in a SOFC may be carried out with any hydrocarbon in the presence of the right catalysts at elevated temperatures. In the case of methane,

CH₄+2O²⁻+xH₂O→CO₂+4H⁺+xH₂O (3)

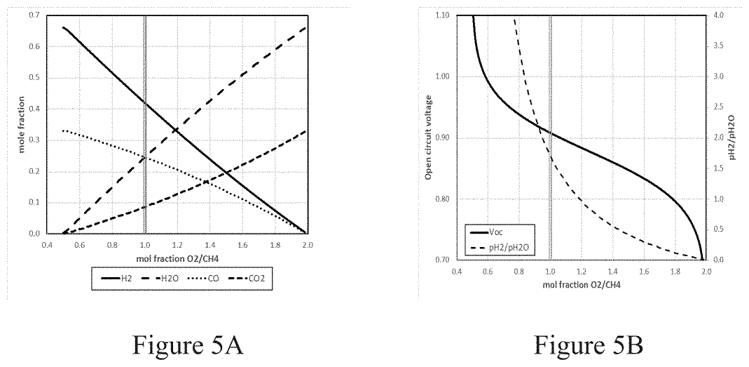

the extent of reaction is ½, meaning that only half as much oxygen has been introduced as would otherwise be required for complete oxidation to CO₂ and H₂O. FIG. 5a shows the mole fraction of gas species in the reformate at equilibrium at 1000K versus the ratio of oxygen to carbon from 0.5 to 2. While other operating conditions may be employed, the ideal operating point for partial oxidation is 1.0, designated by the vertical bar. At this point, the reformate mixture consists of 42% H₂, 25% H₂O, 25% CO and 8% CO₂. The CO is converted to H₂ by the water-gas-shift reaction in the fuel channel downstream. FIG. 5b shows the SOFC potential, E_{sofc}, over the same range on the left-hand axis and the ratio of H₂ to H₂O on the right-hand axis. The value of the ratio of hydrogen to steam at equilibrium at the point where O₂/CH₄=1 can be determined numerically, having a value of 1.71 at 1000K. Without being bound by a particular mechanism it is believed that the primary electrochemical reaction that takes place in a SOFC is the electro-oxidation of hydrogen, where oxygen ions generated from air at the cathode react with hydrogen at the anode. The details are treated in “Modeling Elementary Heterogeneous Chemistry and Electrochemistry in Solid Oxide Fuel Cells” [1] and “Methane Reforming Kinetics Within a Ni-YSZ SOFC Anode Support,” [2]. More details about protonic ceramic membranes may be found in “Thermochemistry of Closed-Cycle Reforming,” [3] and references therein.

### Electrochemical Operation:

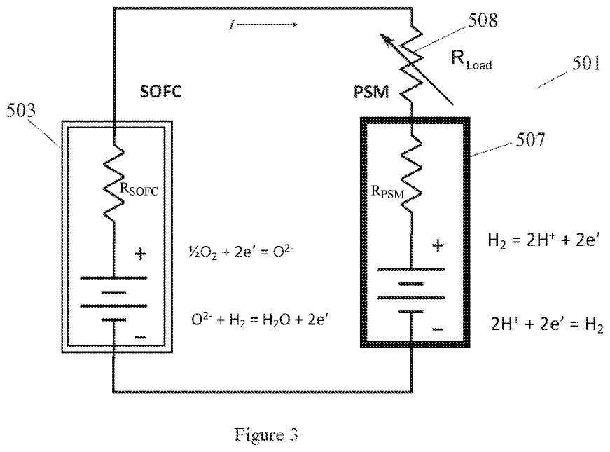

Without being bound by particular mechanisms of operation, the following discussion is provided with respect to preferred embodiments of the present invention and in particular with respect to the current understanding of operation of these embodiments. In these preferred CH₂P systems and methods, there is no requirement for an external electrical power source. In these embodiments, the SOFC and PSM are in electrical series, which means the same current passes through all circuit elements. Electrons generated at the SOFC anode balance the electrons consumed at the PSM cathode. According to these particularly preferred embodiments, the current in the system is determined by the flux of oxygen ions passing through the SOFC. The optimum flux of oxygen ions, in turn, is determined by stoichiometry based on the mass flow rate of carbon-containing species derived from the feedstock. For maximum efficiency, exactly 2 moles of O⁻² are required per mole of carbon. Any additional oxygen can cause extra fuel to be combusted, resulting in extra H₂O in the exhaust, and any less oxygen can result in unutilized CO in the exhaust. At the same time, ideally two moles of H⁺ per mole of O⁻² must pass through the PSM. At all times the ratio of H⁺ to O⁻² is 2-to-1 since the charge, Q, per unit time must be uniform in the circuit. This means that the SOFC has a single operating point on the voltage-current characteristic curve—the voltage, V_{sofc}, being fixed by the current. Changing the current can be accomplished by increasing or decreasing the mass flow rate of the hydrocarbon feedstock. By employing various circuit elements in series and parallel, in principle it is possible to construct a system of arbitrary complexity. The simplest circuit, consisting of a single SOFC 503 cell and PSM 507 cell in electrical series, called a double cell 501, is represented in FIG. 2A and schematically in FIG. 3. The salient feature is that the circuit is a closed loop so the total current is uniform throughout. The current is carried by electrons in the electrodes, interconnects, and external load 508, by oxygen ions in the SOFC 503 and by hydrogen ions in the PSM 507, which means that the flux of hydrogen ions (j_{H}_{⁺}) in the PSM 507 must exactly equal twice the flux of oxygen ions (j_{O}_{^{2−}}) in the SOFC 503.

I=2j_{O}_{^{2−F=}}j_{H}_{^{+F}} (4)

This is a unique operating constraint of the CH₂P 501. It is not possible to operate with any other current in either the SOFC 503 or the PSM 507. Current will flow in the circuit until a rate-limiting step is reached. Oxygen enters the fuel channel as oxygen ions from the SOFC 503 and hydrogen leaves as hydrogen ions from the PSM 507.

The closed circuit requires that the voltages sum to zero. The SOFC is a current source with an internal resistance described by R_{sofc}, with positive terminal at the air electrode. The PSM is a current sink, acting much like a rechargeable battery. That is, the emf opposes the SOFC voltage and increases with increasing hydrogen compression. The associated resistances, including interconnect resistance, are subsumed in Rₚₛₘ. An external load is represented by R_{load}.

E_{sofc}−IR_{sofc}−Eₚₛₘ−IRₚₛₘ−IR_{load}=0 (5)

The preferred device has three separate gas channels. The SOFC is exposed to air on one side and the PSM is exposed to pure hydrogen at some outlet pressure. Both the SOFC and the PSM are preferably in contact with the same reducing gas mixture along the fuel channel. The open circuit voltage (Nernst potential) of the SOFC is defined by the oxygen pressure difference between the cathode(+) and anode(−) as,

$${E}_{sofc} = \frac{R T}{4 F} Ln [ \frac{{P}_{O2 , cathode}}{{P}_{O 2 , anode}} ] \qquad ( 6 )$$

It is convenient to adopt the notation ‘1’ for the SOFC cathode, ‘2’ for the SOFC and PSM anodes, and ‘3’ for the PSM cathode. For the sake of simplicity in the present analysis, it is assumed that oxygen ions are the only species transported in the SOFC and hydrogen ions are the only species transported in the PSM (transference numbers=1). Therefore, the electrochemical potentials at the electrodes are determined only by gas pressures of O₂, H₂ and H₂O, which are related by the mass action law for the water formation reaction.

$${K}_{w} = \frac{{P}_{H 2 O}}{{P}_{H 2} \sqrt{{P}_{O 2}}} \qquad ( 7 )$$

Using this notation, the SOFC ‘sees’ P_{O}_{₂}_{,1} at the cathode and P_{O}_{₂}_{,2} at the anode. The PSM anode ‘sees’ the hydrogen with P_{H}_{₂}_{,2} and the cathode ‘sees’ P_{H}_{₂}_{,3}, where the pressure is that of the pressurized tank determined by electrochemical compression. The utility of the device depends on hydrogen removal such that the hydrogen pressure at the outlet is as high as practical. The same gas composition in the fuel channel is ‘seen’ by both the SOFC and PSM anodes because the distance across the channel, transverse to the direction of flow, is much shorter than the channel length. It is assumed that local gas-phase equilibrium and mixing is achieved much faster than the space velocity of the gas in the channel. The effective pressure of oxygen in the channel, P_{O}_{₂}_{,2}, may be evaluated using the mass action law for the water formation reaction to determine P_{H}_{₂}_{,2} and P_{H}_{₂}_{O,2}. These same pressures are common to the SOFC and PSM anodes. Furthermore, regardless of the partial pressure distribution along the channel, the electrodes are equipotential, reflecting the lowest local electrochemical potential of the channel, which occurs near the outlet.

The open-circuit SOFC emf is,

$${E}_{sofc} = \frac{R T}{2 F} Ln [ \frac{\sqrt{{P}_{{O}_{2} 1}}}{\sqrt{{P}_{{O}_{2} , 2}}} ] = \frac{R T}{2 F} Ln [ \frac{{K}_{w} \sqrt{{P}_{{O}_{2} , 1}} {P}_{{H}_{2} , 2}}{{P}_{{H}_{2} O , 2}} ] = {E}_{sofc}^{°} + \frac{R T}{2 F} Ln [ \frac{{P}_{{H}_{2} , 2} \sqrt{{P}_{{O}_{2} , 1}}}{{P}_{{H}_{2} O , 2}} ] \qquad ( 8 )$$

Where

$${E}_{sofc}^{°} = - \frac{Δ {G}_{H 2 O}}{2 F} . \qquad$$

(The various activation and concentration overpotentials due to electrode reactions will be neglected for convenience in the present analysis.) E_{sofc} is positive because ΔG_{H2O} is negative. The second term on the right gives the correction due to pressures not being in the standard sate. The electrochemical compression potential of the PSM is,

$${E}_{psm} = \frac{R T}{2 F} Ln [ \frac{{P}_{{H}_{2} , 3}}{{P}_{{H}_{2} , 2}} ] \qquad ( 9 )$$

Since the downstream pressure, P_{H}_{₂}_{,3}, is greater than the upstream pressure, P_{H}_{₂}_{,2}, Eₚₛₘ is positive. Substituting into Eq. 5 and rearranging terms,

$${E}_{sofc}^{°} + \frac{R T}{2 F} Ln [ \frac{{( {P}_{{H}_{2} , 2} )}^{2} \sqrt{{P}_{{O}_{2} , 1}}}{{P}_{{H}_{2} O , 2}} ] - \frac{R T}{2 F} Ln [ {P}_{{H}_{2} , 3} ] = I ( {R}_{sofc} + {R}_{psm} + {R}_{load} ) \qquad ( 10 )$$

It is observed that the hydrogen pressure in the fuel channel, which is common to both cells, becomes squared in the second term on the left-hand-side. Current flows when the gas mixture enters the fuel channel and hydrogen leaves either in the exhaust or into a hydrogen collection tank downstream of the PSM. By virtue of the closed circuit, the double cell is self-regulating, providing a built-in feedback control mechanism. The inlet fuel composition and flow rate and hydrogen pressure at the outlet are the only control variables. The amount of oxygen available for partial oxidation is determined by the current flux in the SOFC. Just like with an internal combustion engine, if the inlet fuel mixture is too ‘rich’, unused hydrocarbons and CO will exit as exhaust. If the mixture is too ‘lean’ the hydrogen pressure in the fuel channel will decrease, reducing the SOFC emf. Since the P_{H}_{₂}_{,2} term is squared, the emf of both cells, which is determined by the hydrogen pressure near the exhaust outlet, is very sensitive to small changes in the hydrogen pressure.

The hydrogen pressure at the outlet is an operating parameter of a CH₂P used to optimize economic performance. A typical value of 0.01 atm is used, meaning that 1% of the hydrogen is permitted to slip out with the exhaust. With good air circulation, the partial pressure of oxygen, p_{O}_{₂}_{,1}, in ambient air has a constant value of 0.21. The downstream pressure of compressed hydrogen, P_{H}_{₂}₃, is regulated at steady-state to some constant value, e.g. 5 bar. The steam pressure, P_{H}_{₂}_{O,2}, is unchanged from inlet to outlet in the case of methane. With these assumptions, plus constant operating temperature, the left-hand-side of Eq. 10 gives a constant voltage.

The terms on the right-hand-side constitute the voltage drops due to the series resistances. In the first approximation, cell area specific resistance, ASR, does not depend on current, so R_{sofc} and Rₚₛₘ may be treated as constants. The load resistance, R_{load}, is a control variable, which determines the ratio of H₂ to electrical power generated. With the hydrogen partial pressure in the fuel channel, P_{H}_{₂}_{,2}, fixed at the outlet, the operation is constrained to a single degree of freedom, which fixes the current to a single value. Changing the load resistance does not change the current—it only changes the voltage drop across the load.

### Double-Cell Design:

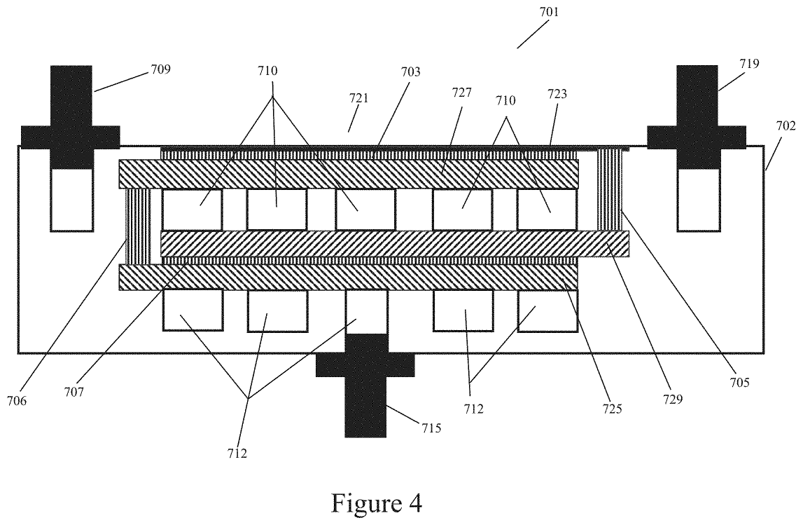

The following double-cell discussion is provided with respect to particularly preferred embodiments of the present invention. According to these embodiments, a double-cell design concept is shown in cross-section in FIG. 4. The double-cell 701 of FIG. 4 is an all-ceramic device 702 that must be co-fired from laminated layers of green ceramic tape or joined by glass seals. The cell 701 is a 3-port 709, 715, 719 device. Fuel, consisting of some mixture of H₂, H₂O, CO, CO₂ and low molecular weight hydrocarbons, is fed in through the top port 709 on the left and flows through the upper integral channel 710, depicted by the white regions perpendicular to the plane of the page, and the gas, depleted of hydrogen, flows out of the exhaust port 719 on the top right. Hydrogen passes through the PSM 707 to the hydrogen collection channel 712 (lower channel), and flows out of the hydrogen port 715 at the bottom center. The integral flow channels 710, 712 must be hermetic with respect to the gases that flow in them. Air 721 is in contact with the SOFC 703 cathode 723. The SOFC 703 is shown on top, with the PSM 707 below on the opposite side of the fuel channel 710. The SOFC 703 anode 727 and the PSM 707 anode 729 and cathode 725 are fabricated with porous Ni/ceramic cermet. Electrically conducting interconnects 705, 706 connect the SOFC 703 anode 727 to the PSM 707 cathode 725 and the SOFC 703 cathode 723 to the PSM 707 anode 729.

The cell 701 depicted in FIG. 4 is technically a 2-cell stack. Several programs to develop monolithic SOFC stacks are ongoing around the world with basically the same challenges posed by the CH₂P architecture. The advantage of the monolithic SOFC design over that of using metallic bipolar plates is that no peripheral gas-tight seals are required. However, one of the difficulties encountered with monolithic SOFC stacks has been eliminated with CH₂P since there is no external wiring and no electrically conducting elements that are exposed to air at high temperatures. Nevertheless, as with monolithic SOFCs, gas must be ported and distributed throughout the cells in hermetic flow channels. Multiple 2-cell stacks depicted in FIG. 4 may be assembled into a larger stack. One intrinsic advantage of CH₂P stacks over SOFC stacks-either monoliths or stacked using bipolar plates—is that the electrical performance of each cell does not depend on the electrical performance of other cells in the stack. Variations in fuel flow from cell to cell will result in different hydrogen fluxes, but otherwise it will not impact system performance. This is because in each individual double-cell, only one SOFC and one PSM are wired together in electrical series. The same current must flow internally in any given cell, but there is no requirement to balance current density between cells. The real challenge is to distribute fuel to all cells as uniformly as possible so that the partial pressure of hydrogen at the exit of the fuel channel is as low as possible, minimizing the amount of hydrogen that is wasted in the exhaust. As long as the individual cells are gas tight, the risk due to single-point failure is minimized because the seal area around the joints is small. This is in contrast to SOFC stacks, where the gas seals are around the perimeter, providing much more opportunity for seal failure. Also, unlike SOFC stacks, where the entire stack must be tested as a completed unit, CH₂P cells can be individually preconditioned and tested prior to assembly into the stack.

### Hydrogen Production:

Without being bound by particular mechanisms of operation, the following discussion is provided with respect to preferred embodiments of the present invention and in particular with respect to the current understanding of operation of these embodiments. In the present embodiment, the hydrogen production rate, it, in units of mole/s, is proportional to the current, I.

$$\dot{n} = \frac{I}{2 F} [ \frac{mol {H}_{2}}{s} ] = \frac{2 \times 3600}{2 F} [ \frac{g}{hr} ] \qquad ( 11 )$$

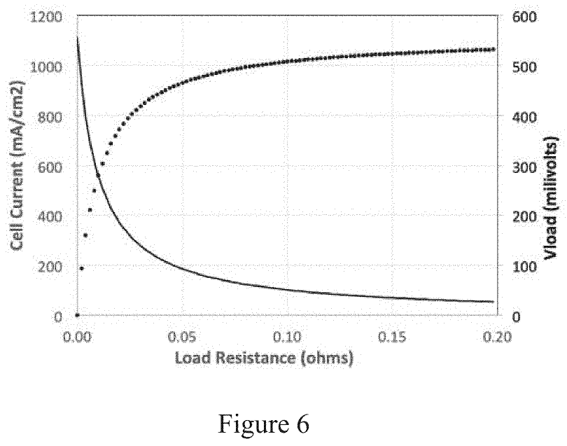

For each ampere of current, 37.3 mg H₂/hr are generated. The maximum hydrogen production occurs when the load resistance is zero. For the case shown in FIG. 6, where the double cell current and voltage are plotted versus the load resistance for a double cell of 50 cm² with R_{sofc}+Rₚₛₘ=0.01 fl, operating with zero external load at 1000K based on ΔG(H₂O)=−192.7 kJ/mol, the current is I=56 A, corresponding to 1.04 mol H₂/hr. An SOFC generates higher voltage than is required to compress hydrogen to realistic pressures. In this case, E_{sofc}−Eₚₛₘ=0.56 volts, which is constant for the gas partial pressures chosen. This voltage is applied across the series resistances. With no load resistance the current is 0.56 volts/0.01 ohms, or 56 amps. If this current is uniformly distributed across the active cell area of 50 cm², the average current density would be 1.12 A/cm². Obviously the current, and thus the hydrogen flux, depend significantly on the cell resistances. One of the advantages of the buried feedthroughs 705, 706 described above is that interconnect resistance can be made very small. Interconnect resistances of even a few milliohms can contribute large parasitic losses for the operation of these cells because the voltages are small.

The model predicts that about 50 grams of H₂ per day may be generated at 5 bar hydrogen in the double cell as described above. At a current of about 56 amps (1.12 A/cm²). This current generates joule heat in the cell by I²R. The most important figure of merit for the cell is the amount of energy required to produce hydrogen. This heat required is equal to the power dissipated per mole of hydrogen produced,

$$\frac{{I}^{2} R [ J / s ]}{[ C / s ]} \times 96485 [ \frac{C}{mol {H}^{+}} ] \times 2 [ \frac{mol {H}^{+}}{mol {H}_{2}} ] \times \frac{1}{1000} [ \frac{kJ}{J} ] = Δ H [ \frac{kJ}{mol} ] \qquad ( 12 )$$

At 56 amps,

$$Δ H = 108 \frac{kJ}{mol} .$$

A rough estimate of the physical size of a CH₂P stack is useful. The thickness of each double cell depicted in FIG. 4 is about 5 mm, plus 1 mm for the air-gap standoff. A circular cell of 8 cm diameter (3.15 in) has an area of 50 cm². If each double cell stack segment generates 51 g/d (2.12 g H₂/h), a stack with about 20 cell segments would be required for producing 1 kg H₂/day (500 mol/d). The stack height would be 12 cm filling a volume of 10×10×12=1200 cm³ (1.2 L) and weighing 1.2 kg at 1 g/cm³. A filling station sized system with an output capacity of 1000 kg H₂/day would consist of 1000 of these stack modules, occupying about 2 m³. and weighing about 2 tons. Such a system with a 10×10 array stacked 10 high would have a footprint of 1 m×1 m×1.2 m tall—about the size of a household refrigerator.

### Energy Margin—Net Effective Work:

Without being bound by particular mechanisms of operation, the following discussion is provided with respect to preferred embodiments of the present invention and in particular with respect to the current understanding of operation of these embodiments. According to these embodiments, stoichiometry determines the ratio of moles of hydrogen produced to the moles of hydrocarbon feedstock. For the case of methane, the enthalpy of combustion (lower heating value, LHV) is −802 kJ/mol, At stoichiometry, 2 moles of H₂ are produced for each mole of CH₄. The combustion enthalpy of the hydrogen produced is −242 kJ/mol (LHV), or −484 kJ/mole of methane. That is, 60% of the fuel enthalpy is captured in the resulting hydrogen. 318 kJ/mol CH₄ are lost including 2×108 kJ/mol already accounted for as heat. The question may be asked: Why not just burn the CH₄ in an internal combustion engine, then? The answer lies in energy conversion efficiency. An ICE operating on methane gas is about 25% efficient, so only about 200 kJ/mol is available to do useful work. A PEM fuel cell running on hydrogen, on the other hand, operates at about 50% efficiency, so about 242 kJ/mol of useful work may be carried out-resulting is a gain of 17% in overall fuel efficiency compared with burning methane in an ICE, plus all the advantages of clean and quiet operation in a PEM fuel cell.

The value proposition for generating electric power with hydrogen fuel cells rather than internal combustion engines lies in the possibility for obtaining more net effective work from a given quantity of fuel. Notwithstanding cleaner, quieter and safer operation, it is still necessary that the net effective work that can be performed for a given application meet or exceed what could otherwise be done if the fuel were simply burned in a heat engine. From the standpoint of just enthalpy, there is no benefit to burning hydrogen in a heat engine at the same engine efficiency unless there is some added benefit to just burning it, for example, to eliminate carbon monoxide and fumes for operation indoors. The real advantage comes from being able to operate a PEM fuel cell at higher net efficiency than an ICE. The difference constitutes the energy margin for fuel processing, including hydrogen separation and electrochemical compression in the PSM.

This is a basis for commercial viability of CH₂P, apart from the many others described herein. This may be generalized for any hydrocarbon fuel where the standard combustion enthalpy, Δ_{H}C° is known. As shown above, CH₂P generates y moles of hydrogen per mole of feedstock. η_{FC} and η_{ICE} are the PEM fuel cell and internal combustion engine efficiency, respectively.

$$( \frac{{η}_{FC}}{{η}_{ICE}} ) \frac{y Δ {H}_{C}^{∘} ( {H}_{2} )}{Δ {H}_{C}^{°} ( fuel )} \geq 1 \qquad ( 13 )$$

ΔH_{C}° (H₂) is the lower heating value of hydrogen (LHV). When the ratio in Eq. 13 is greater than unity, then CH₂P is advantageous on an energy basis. In the case of methane, y=2, 7η_{FC}=0.6 and η_{ICE}=0.25, the energy margin is 1.45. Of course, it is always possible to produce hydrogen at a lower total heating value than the equivalent liquid fuel by reforming additional fuel. This may be of interest when clean energy is at a premium, but ultimately, the trade-off depends on the value of the energy from hydrogen in a particular use scenario derived from a particular hydrocarbon fuel.

### Feedstock Options:

The following discussion is provided with respect to a particularly preferred embodiment of the present invention. Another valuable and preferable characteristic of CH₂P systems and methods of the present embodiment is that most, if not all, the hydrogen generated in the fuel channel can exit in the form of hydrogen ions through the PSM. The oxygen enters in the form of oxygen ions from the SOFC. Some additional oxygen is supplied from steam. That is, for every double negative oxygen ion entering, two positive protons must leave. This constraint may be generalized for any alkanes containing n carbon atoms,

$${C}_{n} {H}_{2 n + 2} + ( \frac{3 n + 1}{2} ) {O}^{2 -} + ( \frac{n - 1}{2} ) {H}_{2} O = {nCO}_{2} + ( 3 n + 1 ) {H}^{+} \qquad ( 14 )$$

(The additional steam to maintain S/C is not included.) Two oxygen atoms are required per carbon atom for complete conversion to CO₂. With increasing carbon number, the ratio of H to C approaches 2:1, so additional oxygen from steam is required.

$$\frac{3 n + 1}{2}$$

moles of hydrogen are recovered per mole of fuel. Methane, n=1, does not require additional oxygen from the steam, providing the simplest case.

In principle, hydrogen can be derived from any hydrocarbon feedstock, but the best candidates for CH₂P in mobile applications are hydrocarbons that require little to no make-up steam (beyond what is required to prevent coking). This case may be generalized as,

CₙHₘOₚ+(2n−p)O²⁻=nCO₂+2(2n−p)H⁺ (15)

The additional constraint requires that,

m=2(2n−p) (16)

Only a few hydrocarbons meet this requirement. The most important ones from the standpoint of potential fuels are methane (CH₄), ethanol (C₂H₆O) and acetic acid (C₂H₄O₂). Ethanol is a particularly attractive feedstock option for a CH₂P double cell. Three moles of hydrogen are generated (3×−242 kJ/mol) per mole of ethanol (ΔH_{c}°=−1330 kJ/mol). 55% of the enthalpy is captured as hydrogen. As a liquid fuel, ethanol has only about 70% of the energy density of diesel on a volumetric basis. The combustion enthalpy of diesel is about ΔH_{c}°=−33.1 MJ/L. A liter of ethanol will generate 12.4 MJ/L of hydrogen when processed using a CH₂P system. The energy margin from Eq. 13 on a volumetric basis is

$$( \frac{0.6}{0.25} ) ( \frac{12.4}{33.1} ) = 0.9 ,$$

slightly less combusting diesel in an ICE, but much more favorable than combusting ethanol in the same engine at the same efficiency.

If water addition is included, then the generalized CH₂P operating condition becomes,

$${C}_{n} {H}_{m} {O}_{p} + ( n + \frac{m}{4} - \frac{p}{2} ) {O}^{2 -} + ( n - \frac{m}{4} - \frac{p}{2} ) {H}_{2} O = {nCO}_{2} + 2 ( n + \frac{m}{4} - \frac{p}{2} ) {H}^{+} \qquad ( 17 )$$

In this case,

$$n + \frac{m}{4} - p / 2$$

moles of H₂ are produced per mole of feedstock. For example, pyrolysis gas from cellulose, C₆H₁₀O₅, when used as the feedstock, consumes one mole of steam while generating three moles of hydrogen per mole of cellulose. Depending on the water content of the feedstock, supplemental steam may not be required at all with certain cellulosic biomass. The process of turning pyrolysis oil (bio-oil) into a gasoline or diesel substitute is difficult because bio-oil generally contains too much oxygen to make a good fuel for combustion. On the other hand, gasified biomass is nearly the ideal feedstock for CH₂P, presenting interesting options for producing hydrogen from waste streams.

### CONCLUSIONS

CH₂P offers a completely new, elegant, and efficient pathway for transitioning to hydrogen power. It has been shown that with preferable thermal and electrical integration between SOFC and PSM cells, hydrocarbon feedstocks may be converted to hydrogen. In some cases, this may be done with a net gain in available work, extending the range and endurance of mobile power systems over conventional liquid fuels when combusted in heat engines. Furthermore, CH₂P obviates the need for specialized fuels for engines, for example gasoline, diesel and jet fuel. Hydrogen may be generated from a wide range of hydrocarbon feedstocks. Solid fuels from fossil-based and plant-based sources are readily available. Biomass and biofuels provide an opportunity to increase the use of carbon-neutral fuels while reducing dependence on imported petroleum. With the CH₂P systems and methods herein described, hydrogen may be produced remotely at almost any scale from a few grams to tons without the need for access to a crude oil, power grid or natural gas pipelines.

### REFERENCES INCORPORATED HEREIN BY REFERENCE

[1] W. Grover Coors, “Thermochemistry of Closed-Cycle Reforming,” May (2018), DOI: 10 13140/RG.2.2.28666.18883
[2] R. J. Kee, et. al., “Modeling Elementary Heterogeneous Chemistry and Electrochemistry in Solid Oxide Fuel Cells,” J. Electrochem. Soc. 152 (12) A2427-A2440 (2005)
[3] R. J. Kee, et. al., “Methane Reforming Kinetics Within a Ni-YSZ SOFC Anode Support,” Applied Catalysis A: General 295 40-51 (2005)

1. A combined hydrogen and electrical power generation system comprising:
a solid oxide fuel cell (SOFC) having a cathode and an anode; and
a protonic ceramic hydrogen separation membrane (PSM) having a cathode and an anode;
wherein the SOFC and the PSM are connected in electrical series having a common current.

2. The system of claim 1, wherein the cathode of the SOFC is in electrical connection with the anode of the PSM, and the cathode of the PSM is in electrical connection with the anode of the SOFC.

3. The system of claim 1, further comprising a load connected in electrical series with the SOFC and the PSM.

4. The system of claim 3, wherein the load is disposed between the cathode of the SOFC and the anode of the PSM or between the anode of the SOFC and the cathode of the PSM.

5. The system of claim 3, wherein the load is selected from the group consisting of: a heater for the SOFC and/or PSM internal to the system, a preheater for preheating steam and/or a hydrocarbon fuel source to be used in the system, a gas compressor for compressing hydrogen produced by the system, and a load external to thermodynamic operation of the system being selected from the group consisting of a battery bank, a process control system, facility or plant loads, and an external power grid.

6. The system of claim 1, wherein the system requires no connection to an external power source for providing powering the system.

7. The system of claim 1, wherein the system has no connection to an external power source for providing power to the system.

8. The system of claim 1, further comprising an oxygen supply, a fuel gas channel, and a product hydrogen channel.

9. The system of claim 8, wherein
the oxygen supply is in fluid communication with the cathode of the SOFC,
the fuel gas channel is a common channel disposed between and in fluid communication with both the anode of the SOFC and the anode of the PSM, and
the product hydrogen channel is in fluid communication with the cathode of the PSM.

10. The system of claim 8, wherein the fuel gas channel has an inlet and an outlet, wherein between the inlet and the outlet the fuel gas channel is closed to the introduction or removal of gas species other than introduction of oxygen at the SOFC anode and removal of hydrogen at the PSM anode.

11. The system of claim 8, wherein the oxygen supply, the fuel gas channel, and the product hydrogen channel are each adapted for continuous or semi-continuous flow.

12. The system of claim 8, wherein
the oxygen supply comprises ambient air, compressed air, or compressed oxygen,
the fuel gas channel has: an inlet and an outlet; a gas content at the inlet containing a mixture of gases including H₂O, CO, CO₂, H₂, and low molecular weight hydrocarbons; and a gas content at the outlet containing the same gases but with a reduced mole fraction of H₂, and
the product hydrogen channel comprises H₂.

13. The system of claim 12, wherein the gas content at the outlet of the fuel gas channel has less than 10 mol % H₂.

14. The system of claim 1, wherein the system further comprising a fuel gas supply derived from fossil or renewable fuel sources.

15. The system of claim 1, wherein supply lines to the system are in heat exchange with product and exhaust lines exiting the system, and wherein the system is insulated in a thermodynamic enclosure to minimize heat transfer to the ambient environment.

16. A combined hydrogen and electrical power generation system comprising:
a solid oxide fuel cell (SOFC) having a cathode and an anode;
a protonic ceramic hydrogen separation membrane (PSM) having a cathode and an anode; and
an oxygen supply, a fuel gas channel, and a product hydrogen channel;
wherein:
the SOFC and the PSM are connected in electrical series having a common current,
the cathode of the SOFC is in electrical connection with the anode of the PSM, and the cathode of the PSM is in electrical connection with the anode of the SOFC,
the oxygen supply, the fuel gas channel, and a product hydrogen channel are each adapted for continuous or semi-continuous flow,
the oxygen supply comprising ambient air, compressed air, or compressed oxygen which is in fluid communication with the cathode of the SOFC,
the product hydrogen channel comprising hydrogen which is in fluid communication with the cathode of the PSM,
the fuel gas channel is a common channel disposed between and in fluid communication with both the anode of the SOFC and the anode of the PSM,
the fuel gas channel has: an inlet and an outlet; a gas content at the inlet containing a mixture of gases including H₂O, CO, CO₂, H₂, and low molecular weight hydrocarbons; and a gas content at the outlet containing the same gases but less than 10 mol % H₂,
between the inlet and the outlet the fuel gas channel is closed to the introduction or removal of gas species other than introduction of oxygen at the SOFC anode and removal of hydrogen at the PSM anode, and
the system requires no connection to an external power source for providing power to the system.

17. The system of claim 16, further comprising a fuel gas supply derived from fossil or renewable fuel sources and an external load connected in electrical series with the SOFC and the PSM,
wherein:
the external load is disposed between the cathode of the SOFC and the anode of the PSM or between the anode of the SOFC and the cathode of the PSM, and
the external load is selected from the group consisting of: a heater for the SOFC and/or PSM internal to the system, a preheater for preheating steam and/or a hydrocarbon fuel source to be used in the system, a gas compressor for compressing hydrogen produced by the system, and a load external to thermodynamic operation of the system being selected from the group consisting of a battery bank, a process control system, facility or plant loads, and an external power grid, and wherein supply lines to the system are in heat exchange with product and exhaust lines exiting the system, and wherein the system is insulated in a thermodynamic enclosure to minimize heat transfer to the ambient environment.

18. A method for generating hydrogen and electrical power, the method comprising the steps of:
(i) providing a combined hydrogen and electrical power generation system comprising:
a solid oxide fuel cell (SOFC) having a cathode and an anode;
a protonic ceramic hydrogen separation membrane (PSM) having a cathode and an anode;
wherein the SOFC and the PSM are connected in electrical series having a common current, and wherein the cathode of the SOFC is in electrical connection with the anode of the PSM, and the cathode of the PSM is in electrical connection with the anode of the SOFC.
(ii) contacting the cathode of the SOFC with an oxygen supply,
(iii) contacting both the anode of the SOFC and the anode of the PSM with a fuel gas,
(iv) receiving hydrogen from the cathode of the PSM, and
(v) allowing a current to flow from the cathode of the SOFC to the anode of the PSM, across an electrolyte disposed between the anode of the PSM and the cathode of the PSM, from the cathode of the PSM to the anode of the SOFC, across an electrolyte disposed between the anode of the SOFC and back to the cathode of the SOFC.

19. The method of claim 18, wherein:
the system further comprises a load connected in electrical series with the SOFC and the PSM, wherein the load is disposed between the cathode of the SOFC and the anode of the PSM or between the anode of the SOFC and the cathode of the PSM, and wherein the load is selected from the group consisting of: a heater for the SOFC and/or PSM internal to the system, a preheater for preheating steam and/or a hydrocarbon fuel source to be used in the system, a gas compressor for compressing hydrogen produced by the system, and a load external to thermodynamic operation of the system being selected from the group consisting of a battery bank, a process control system, facility or plant loads, and an external power grid,
the method further comprises the step of allowing the current to flow through the load.

20. The method of claim 18, wherein the system or method require no connection to an external power source for providing powering the system or method.

21. The method of any of claim 18, wherein step (iii) is performed by contacting both the anode of the SOFC and the anode of the PSM with a fuel gas disposed in a common channel between and in fluid communication with both the anode of the SOFC and the anode of the PSM, wherein the common channel has an inlet and an outlet, wherein between the inlet and the outlet the fuel gas channel is closed to the introduction or removal of gas species other than introduction of oxygen at the SOFC anode and removal of hydrogen at the PSM anode.

22. The method of claim 18, wherein:
the oxygen supply comprises ambient air, compressed air, or compressed oxygen,
the fuel gas has: an inlet and an outlet; a gas content at the inlet containing a mixture of gases including H₂O, CO, CO₂, H₂, and low molecular weight hydrocarbons; and a gas content at the outlet containing the same gases but with a reduced mole fraction of H₂, and
hydrogen is received in a hydrogen reservoir downstream of the cathode of the PSM.
